(19) United States
(12) Patent Application Publication
(10) Pub. No.: US 2010/0108481 A1
(43) Pub. Date: May 6, 2010

(54) Light-emitting keyboard with a membrane circuit board incorporated therein

(75) Inventor: Wen Ching Chiang, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: CHICONY ELECTRONICS CO., LTD, Taipei Hsien (TW)

(21) Appl. No.: 12/453,852

(22) Filed: May 26, 2009

(30) Foreign Application Priority Data
Oct. 30, 2008 (TW) 97141805

(51) Int. Cl. H01H 9/18

(52) U.S. Cl. 200/310; 200/512

(57) ABSTRACT

The present invention relates to a light-emitting keyboard, comprising: a membrane circuit board whose bottom surface is printed with a light guide ink; a light source provided on one side of the membrane circuit board for projecting light to enter the light guide ink of the membrane circuit board; a first reflector disposed underneath the membrane circuit board to reflect a portion of the light that escapes from the membrane circuit board to enter the light guide ink of the membrane circuit board; a second reflector provided on top of the membrane circuit board to reflect a portion of the light that does not pass therethrough back towards the light guide ink; a supporting plate disposed on top of the second reflector; a scissor assembly disposed on top of the supporting plate; a keycap disposed on top of the scissor assembly; and an elastic contact body having a contact portion.

### BACKGROUND OF THE INVENTION

1. Field of the Invention

The present invention relates to a light-emitting keyboard, and more particularly, to a light-emitting keyboard that facilitates reducing the manufacturing costs and overall thickness.

2. Description of the Related Art

With the popularity of computer, users not only pursue better computer efficiency but also pay more attention to the function and design of computer accessories such as mouse and keyboard. As computer has become an indispensable device in nearly every aspect of modern life from telecommunication, commerce, editing to graphics design, some manufacturers equip keyboard, one of the most important input devices for computer, with backlit keys so that the user can perform input tasks under inadequate lighting. Besides, the back lighting makes the keyboard look fancy.

A conventional light-emitting keyboard typically includes a light guide. For example, the light-emitting keyboard disclosed in ROC Publication No. 509955 comprises: a keyboard portion; and a backlit device having a light guide, a reflector and a light source; wherein the light travels in the light guide and then is reflected to enter the keyboard portion by the reflector. In addition, the bottom surface of the light guide is provided with a plurality of light reflecting portions corresponding to the transparent spacer layer such that the light originated from the light source and entering the light guide is refracted when reaching the light reflecting portions, and then said light is reflected to the keyboard portion to reinforce the luminescent efficiency of the key. The light reflecting portions may be formed by printing a plurality of reflecting dots onto the bottom surface of the light guide, or they may be formed integrally with the bottom surface of the light guide creating a rough reflecting surface.

The light guide is an indispensable component for a light-emitting keyboard in the aforementioned prior techniques. However, as the light guide is of a certain thickness, the overall thickness of the light-emitting keyboard incorporating said light guide increases correspondingly. Moreover, the inclusion of a light guide also increases the overall manufacturing costs of a light-emitting keyboard.

Accordingly, how to effectively reduce the overall thickness as well as the manufacturing costs of a light-emitting keyboard is an important issue for the manufacturers.

### SUMMARY OF THE INVENTION

An object of the present invention is to provide a light-emitting keyboard and a membrane circuit board incorporated therewithin that facilitate reducing the manufacturing costs.

Another object of the present invention is to provide a light-emitting keyboard and a membrane circuit board incorporated therewithin that facilitate increasing the luminescent efficiency.

Yet another object of the present invention is to provide a light-emitting keyboard and a membrane circuit board incorporated therewithin that facilitate reducing the overall thickness of the keyboard.

A light-emitting keyboard that achieves the aforementioned objects comprises: a membrane circuit board whose bottom surface is printed with a light guide ink; a light source provided on one side of the membrane circuit board for projecting light to enter the light guide ink of the membrane circuit board; a first reflector disposed underneath the membrane circuit board to reflect a portion of the light that escapes from the membrane circuit board to enter the light guide ink of the membrane circuit board; a second reflector disposed on top of the membrane circuit board to reflect a portion of the light that does not pass therethrough back towards the light guide ink, the second reflector being provided with a first opening; a supporting plate disposed on top of the second reflector, the supporting plate being provided with a second opening corresponding to the first opening of the second reflector and a plurality of first and second fixation brackets adjacent to the second opening; a scissor assembly disposed on top of the supporting plate, the scissor assembly being provided with a top hinge portion, a bottom hinge portion engaged with the plurality of first and second fixation brackets of the supporting plate and a third opening corresponding to the first and second openings; a keycap disposed on top of the scissor assembly, the keycap being provided with a top retaining portion engaged with the top hinge portion of the scissor assembly; and an elastic contact body having a contact portion, the elastic contact body being configured to pass through the first, second and third openings so as to be disposed between the keycap and the membrane circuit board.

The abovementioned membrane circuit board includes an upper plate, a spacer plate and a lower plate, and the light guide ink is rolled over the bottom surface of the lower plate.

The abovementioned light guide ink is distributed evenly over the bottom surface of the lower plate.

The abovementioned light guide ink is distributed unevenly over the bottom surface of the lower plate.

The light guide ink is printed over the bottom surface of the lower plate in the form of matrix.

The size of the light guide ink printed over the bottom surface of the lower plate varies depending on the size of each keycap.

The closer the distance between the light guide ink and the light source, the lower the density of the light guide ink; the farther the distance between the light guide ink and the light source, the greater the density of the light guide ink.

The light-emitting keyboard of the present invention further comprises a reinforcement board disposed between the membrane circuit board and the second reflector, the reinforcement board being provided with a plurality of fasteners.

A plurality of fastener apertures are configured on the membrane circuit board, the second reflector and the supporting plate respectively, allowing the plurality of fasteners of the reinforcement board to pass therethrough such that the reinforcement board, the membrane circuit, the second reflector and the supporting plate may be secured in a stack.

The light source is controlled by a base circuit board and provided adjacent to a lateral side of the membrane circuit board.

A membrane circuit board that achieves the abovementioned objects is incorporated in a keyboard. The membrane circuit board comprises: an upper plate; a spacer plate; and a lower plate whose bottom surface is printed with a light guide ink that receives the light originated from a light source and then radiates the light upward to illuminate the keyboard.

By having the bottom surface of the membrane circuit board incorporated in the light-emitting keyboard of the present invention printed with the light guide ink, the keyboard does not need to include an additional light guide. Consequently, the manufacturing costs and overall thickness of the keyboard can be reduced, and the luminescent efficiency can be increased as well.

### BRIEF DESCRIPTION OF THE DRAWINGS

FIG. 1 is an exploded view showing a light-emitting keyboard of the present invention.

FIG. 2 is a sectional view showing a light-emitting keyboard of the present invention.

FIG. 3 is an exploded view showing a membrane circuit board incorporated in the light-emitting keyboard of the present invention.

FIG. 4 is a bottom view showing a membrane circuit board incorporated in the light-emitting keyboard of the present invention.

FIG. 5 is a bottom view showing another embodiment of a membrane circuit board incorporated in the light-emitting keyboard of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

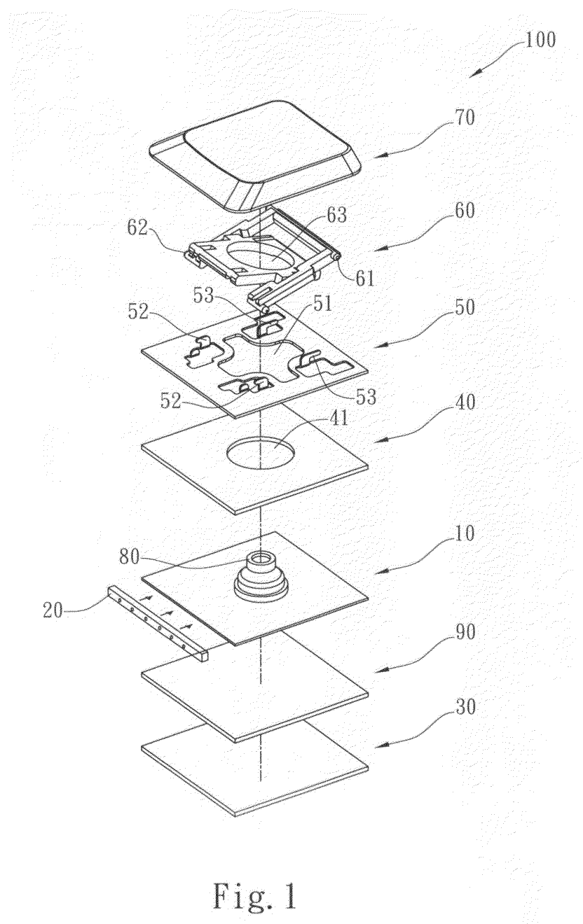

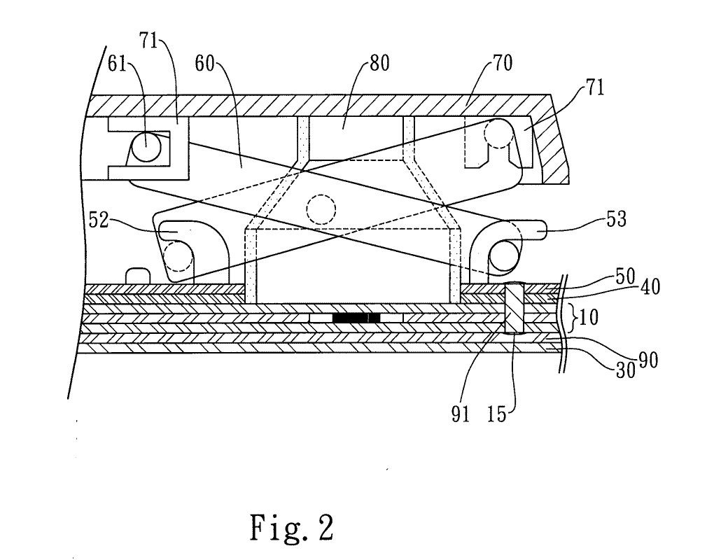

FIGS. 1 and 2 show an exploded view and a sectional view of the first embodiment of a light-emitting keyboard of the present invention, respectively. For illustration purposes, a person skilled in the art shall understand that a single key unit of the light-emitting keyboard illustrated in the drawings represents a group of similar key units on the keyboard. Modules similar to those equipped in a keyboard, such as top casing and bottom casing, are omitted for illustration purposes.

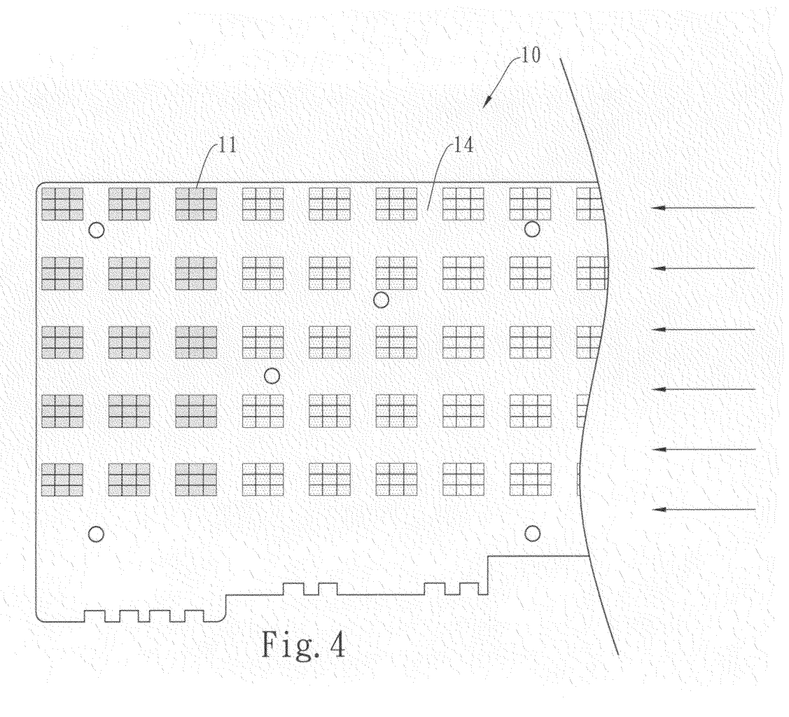

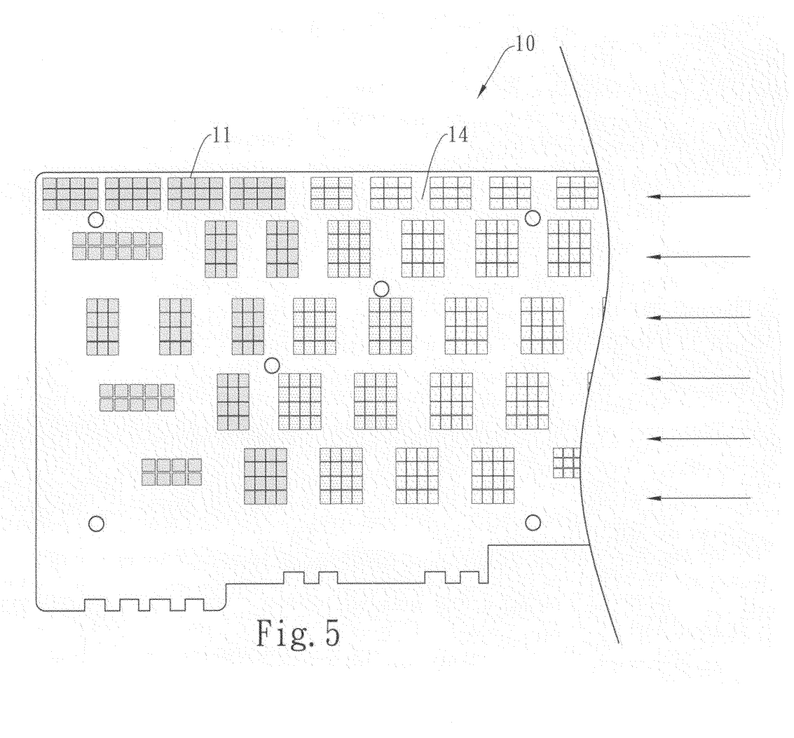

A light-emitting keyboard 100 of the present invention comprises: a membrane circuit board 10 whose bottom surface is printed with a light guide ink 11 (see FIGS. 4 and 5); a light source 20 disposed on one side of the membrane circuit board 10 for projecting light to enter the light guide ink 11 of the membrane circuit board 10; a first reflector 30 disposed underneath the membrane circuit board 10 to reflect a portion of the light that escapes from the membrane circuit board 10 to enter the light guide ink 11 of the membrane circuit board 10; a second reflector 40 provided on top of the membrane circuit board 10 to reflect a portion of the light that does pass therethrough back towards the light guide ink 11; a supporting plate 50 disposed on top of the second reflector 40, a scissor assembly 60 disposed on top of the supporting plate 50; a keycap 70 disposed on top of the scissor assembly 60; and an elastic contact body 80 having a contact portion.

Referring to FIGS. 1 and 2, the light source 20 is controlled and powered by a base circuit board (not shown) and disposed adjacent to a lateral side of the membrane circuit board 10; the second reflector 40 is provided with a first opening 41; the supporting plate 50 is provided with a second opening 51 opposed to the first opening 41 of the second reflector 40 and a plurality of first and second fixation brackets 52 and 53 adjacent to the second opening 51; the scissor assembly 60 is provided with a top hinge portion 61, a bottom hinge portion 62 and a third opening 63 corresponding to the first and second openings 41 and 51; the keycap 70 is provided with a top retaining portion 71; wherein the bottom hinge portion 62 of the scissor assembly 60 is engaged with the plurality of first and second fixation brackets 52 and 53 of the supporting plate 50 respectively and the top hinge portion 61 of the scissor assembly 60 is coupled to the top retaining portion 71 of the keycap 70 such that the keycap 70, the scissor assembly 60 and the supporting plate 50 are engaged together; and wherein the elastic contact body 80 passes through the first opening 41, the second opening 51 and the third opening 63 so as to be disposed between the keycap 70 and the membrane circuit board 10.

The light-emitting keyboard 100 of the present invention further comprises a reinforcement board 90 disposed between the membrane circuit board 10 and the second reflector 40, the reinforcement board 90 being provided with a plurality of fasteners 91. Moreover, a plurality of fastener apertures 15 corresponding to the plurality of fasteners 91 of the reinforcement board 90 are configured on the membrane circuit board 10, the second reflector 40 and the supporting plate 50 respectively, allowing the plurality of fasteners 91 to pass therethrough such that the reinforcement board 90, the membrane circuit board 10, the second reflector 40 and the supporting plate 50 can be secured in a stack. Therefore, the reinforcement board 90 can stabilize and reinforce the structures and components disposed thereon, including the membrane circuit board 10, the second reflector 40, the supporting plate 50, the scissor assembly 60 and the keycap 70.

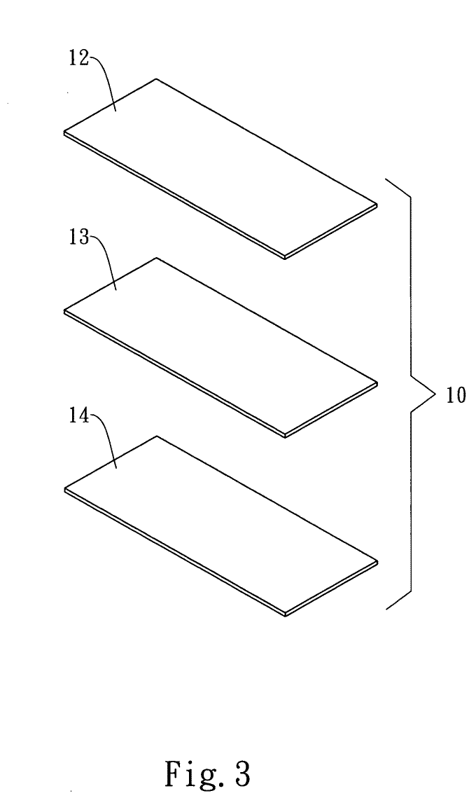

FIGS. 3 and 4 show an exploded view and a bottom view of a membrane circuit board incorporated in the light-emitting keyboard of the present invention, respectively. The membrane circuit board 10 comprises an upper plate 12, a spacer plate 13 and a lower plate 14, and the light guide ink 11 is rolled over the bottom surface of the lower plate 14. As shown in FIG. 4, the light guide ink 11 is distributed evenly over the bottom surface of the lower plate 14; wherein the closer the distance between the light guide ink 11 and the light source 20, the lower the density of the light guide ink 11; and wherein the farther the distance between the light guide ink 11 and the light source 20, the greater the density of the light guide ink.

In this embodiment, the light guide ink 11 is printed over the bottom surface of the lower plate 14 in the form of matrix. Alternatively, the light guide ink 11 may be printed over the bottom surface of the lower plate 14 in the form of reticulation or in any other forms.

FIG. 5 is a bottom view showing another embodiment of a membrane circuit board incorporated in the light-emitting keyboard of the present invention. The only difference between this embodiment and the embodiment of FIG. 4 is that, in this embodiment, the light guide ink 11 is printed under each keycap 70 correspondingly, and the size of the light guide ink 11 printed over the bottom surface of the lower plate 14 varies depending on the size of each keycap 70. Consequently, the light guide ink 11 is distributed unevenly over the bottom surface of the lower plate 14.

The bottom surface of the membrane circuit board 10 incorporated in the light-emitting keyboard 100 of the present invention is printed with the light guide ink 11 to receive the light originated from the light source 20 and then direct the light in a vertical upward direction; wherein a portion of the light sequentially passes through the membrane circuit board 10, the second reflector 40, the supporting plate 50 and the scissor assembly 60, and then reaches the keycap 70 to illuminate the keycap 70; meanwhile, the second reflector 40 reflects another portion of the light that does not pass therethrough back towards the light guide ink 11 of the membrane circuit board 10 such that the portion of the light can again be radiated towards the keycap 70 to illuminate the keycap 70 and further reinforce the luminescent efficiency of the light-emitting keyboard.

In addition, when the light originated from the light source 20 is radiated in a vertical upward direction via the light guide ink 11, a potion of the light may dissipate downwardly and then be reflected upward by the first reflector 30 to pass through the components and structures configured between the first reflector 30 and the keycap 70, including the membrane circuit board 10, the second reflector 40, the supporting plate 50 and the scissor assembly 60, thereby to illuminate the keycap 70 and further reinforce the luminescent efficiency of the light-emitting keyboard 100.

By having the bottom surface of the membrane circuit board incorporated in the light-emitting keyboard of the present invention printed with the light guide ink, the keyboard does not need to include an additional light guide. Consequently, the manufacturing costs and overall thickness of the keyboard can be reduced, and the luminescent efficiency can be increased as well.

While this invention has been described by way of examples and in terms of preferred embodiments, it is to be understood that this invention is not limited hereto, and that various changes and modifications can be made herein without departing from the spirit and scope of this invention as defined by the appended claims. In addition, the scope of the present invention is not limited to the applications listed in the specification. For example, the light guide ink may be printed over the bottom surface of the lower plate of the membrane circuit board by rolling, laser beams, etching or any applicable methods.

What is claimed is:

1. A light-emitting keyboard, comprising:
a membrane circuit board whose bottom surface is printed with a light guide ink;
a light source disposed on one side of the membrane circuit board for projecting light to the light guide ink of the membrane circuit board;
a first reflector disposed underneath the membrane circuit board to reflect a portion of the light that escapes from the membrane circuit board to enter the light guide ink of the membrane circuit board;
a second reflector disposed on top of the membrane circuit board to reflect a portion of the light that does not penetrate therethrough back towards the light guide ink, the second reflector being provided with a first opening;
a supporting plate disposed on top of the second reflector, the supporting plate being provided with a second opening corresponding to the first opening of the second reflector and a plurality of first and second fixation brackets adjacent to the second opening;
a scissor assembly disposed on top of the supporting plate, the scissor assembly being provided with a top hinge portion, a bottom hinge portion engaged with the plurality of first and second fixation brackets of the supporting plate respectively and a third opening corresponding to the first and second openings;
a keycap disposed on top of the scissor assembly, the keycap being provided with a top retaining potion engaged with the top hinge portion of the scissor assembly; and
an elastic contact body having a contact portion, the elastic contact body being configured to pass through the first, second and third openings so as to be disposed between the keycap and the membrane circuit board.

2. The light-emitting keyboard according to claim 1, wherein the membrane circuit board includes an upper plate, a spacer plate and a lower plate, and the light guide ink is rolled over the bottom surface of the lower plate.

3. The light-emitting keyboard according to claim 2, wherein the light guide ink is distributed evenly over the bottom surface of the lower plate.

4. The light-emitting keyboard according to claim 2, wherein the light guide ink is distributed unevenly over the bottom surface of the lower plate.

5. The light-emitting keyboard according to claim 2, wherein the light guide ink is printed over the bottom surface of the lower plate in the form of matrix.

6. The light-emitting keyboard according to claim 4, wherein the size of the light guide ink printed over the bottom surface of the lower plate varies depending on the size of each keycap.

7. The light-emitting keyboard according to claim 1, wherein the closer the distance between the light guide ink and the light source, the lower the density of the light guide ink; the farther the distance between the light guide ink and the light source, the greater the density of the light guide ink.

8. The light-emitting keyboard according to claim 1 further comprising a reinforcement board disposed between the membrane circuit board and the second reflector, the reinforcement board being provided with a plurality of fasteners.

9. The light-emitting keyboard according to claim 8, wherein a plurality of fastener apertures are configured on the membrane circuit board, the second reflector and the supporting plate respectively, allowing the plurality of fasteners of the reinforcement board to pass therethrough such that the reinforcement board, the membrane circuit board, the second reflector and the supporting plate are secured in a stack.

10. The light-emitting keyboard according to claim 1, wherein the light source is controlled by a base circuit board and provided adjacent to a lateral side of the membrane circuit board.

11. A membrane circuit board incorporated in a keyboard, comprising:
an upper plate;
a spacer plate; and
a lower plate whose bottom surface is printed with a light guide ink that receives the light originated from a light source to illuminate the keyboard.

12. The membrane circuit board according to claim 11, wherein the light guide ink is rolled over the bottom surface of the lower plate.

13. The membrane circuit board according to claim 11, wherein the light guide ink is distributed evenly over the bottom surface of the lower plate.

14. The membrane circuit board according to claim 11, wherein the light guide ink is distributed unevenly over the bottom surface of the lower plate.

15. The membrane circuit board according to claim 11, wherein the light guide ink is printed over the bottom surface of the lower plate in the form of matrix.

16. The membrane circuit board according to claim 14, wherein the size of the light guide ink printed over the bottom surface of the lower plate varies depending on the size of each keycap.

17. The membrane circuit board according to claim 11, wherein the closer the distance between the light guide ink and the light source, the lower the density of the light guide ink; the farther the distance between the light guide ink and the light source, the greater the density of the light guide ink.
